(19) United States
(12) Patent Application Publication
(10) Pub. No.: US 2007/0094426 A1
(43) Pub. Date: Apr. 26, 2007

(54) KVM switch supporting IPMI communications with computing devices

(75) Inventors: Han-Chung Chiang, Taipei Hsien (TW); Shih-Yuan Huang, Taipei Hsien (TW); Chieh-Kwei Lee, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Aten International Co., Ltd.

(21) Appl. No.: 11/257,590

(22) Filed: Oct. 24, 2005

(51) Int. Cl. G06F 13/38; G06F 15/16

(52) U.S. Cl. 710/73; 709/217

(57) ABSTRACT

A KVM switch with Intelligent Platform Management Interface (IPMI) function is disclosed. The present KVM switch includes a computer interface, a console interface, a network interface circuit, a processor and a memory. The computer interface is capable of connection to at least one computing device having a baseboard management controller (BMC). The console interface is capable of connection to at least one console device. The network interface circuit is capable of connection to the BMC via a network. The processor routes a communication path between the computing device and the console device. The memory stores an IPMI firmware. The processor manages the computing device through the BMC by executing the IPMI firmware, and generates an IPMI menu.

### BACKGROUND

1. Field of Invention

The present invention relates to a KVM switch. More particularly, the present invention relates to a KVM switch supporting the Intelligent Platform Management Interface (IPMI) communications with computing devices.

2. Description of Related Art

With the rapid development in information technology, computers and their peripherals have become very popular. Typically, each computer is equipped with one console device including a keyboard, a mouse and a monitor. However, this kind of configuration is a waste of money and occupies too much space if there is only one user to manipulate these computers. Referring to FIG. 1, a keyboard-video-mouse (KVM) switch 100 is therefore proposed to use a single console device 114 to manage several computers 112. Using the KVM switch 100 can reduce hardware cost and decreases waste of space while simultaneously conquering the problem of compatibility between different interfaces.

By the KVM switch 100, the user (i.e. who uses the console device 114) and the computers 112 can be separated from each other, such as being located in different rooms or even on different floors. The computers 112 placed in a data center may be servers or workstations, which generally run day and night for continuing service. However, when the server connected to the KVM switch crashes due to hardware or operating system error, the system administrator cannot easily check or reboot the server located far from him. This is inconvenient and wastes time and effort to check or reboot the server by physically going to the data center rather than by remotely controlling the server.

Intelligent Platform Management capabilities are a key component in providing enterprise-class management for high-availability systems. The term “Intelligent Platform Management” refers to autonomous monitoring and recovery features implemented directly in platform management hardware and firmware. Generally, platform status information can be obtained and recovery actions initiated under situations where system management software and normal ‘in-band’ management mechanisms are unavailable, and even when the computer is in a powered down state.

FIG. 2 is a schematic view of a conventional Intelligent Platform Management Interface (IPMI) system 200, which includes a plurality of computers 212 and a remote terminal 218. Typically, each of the computers 212 has a baseboard management controller (BMC), and the remote terminal 218 includes a console device as mentioned above and a computer with IPMI management software installed therein. The remote terminal 218 communicates with the baseboard management controller of each computer 212 via a network 218, e.g. by a network hub 217.

The independent monitoring, logging, and access functions available through the IPMI system 200 provide a level of manageability built-in to the platform hardware. This can support computer 212 having the baseboard management controller 212 rather than installing any system management software available for the particular operating system.

### SUMMARY

It is therefore an aspect of the present invention to provide a KVM switch, which supports the Intelligent Platform Management Interface (IPMI) function, thus improving the user management and monitoring.

According to one preferred embodiment of the present invention, the KVM switch comprises a computer interface, a console interface, a processor, a network interface circuit and an Intelligent Platform Management Interface (IPMI) module. The computer interface is capable of connection to at least one computing device, and the computing device has a baseboard management controller (BMC). The console interface is capable of connection to at least one console device.

The processor is electrically connected to the computer interface and the console interface and routes a communication path between the computing device and the console device. The network interface circuit is capable of connection to the BMC via a network. The IPMI module is electrically connected to the processor and the network interface circuit and manages the computing device by the BMC via the network and generates an IPMI menu for the console device.

It is another aspect of the present invention to provide a KVM switch, which can provide an IPMI menu for a remote terminal by the over-IP technique, making the user at the remote terminal able to manage, monitor, control, and even reboot the KVM located far from the user.

According to another preferred embodiment of the present invention, the KVM switch comprises a computer interface, a console interface, a network interface circuit, a processor and an Intelligent Platform Management Interface (IPMI) module. The computer interface is capable of connection to at least one computing device, and the computing device has a baseboard management controller (BMC). The console interface is capable of connection to at least one console device. The network interface circuit is capable of connection to the BMC and a remote terminal via a network.

The processor is electrically connected to the computer interface, the console interface and the network interface circuit and routes communication paths among the computing device, the console device and the remote terminal. The IPMI module is electrically connected to the processor and the network interface circuit and manages the computing device by the BMC via the network and generates an IPMI menu for at least one of the console device and the remote terminal.

It is still another aspect of the present invention to provide a KVM switch, which supports the IPMI standard by executing its IPMI firmware stored in the memory. The KVM switch can establish an IPMI communication between a computing device and one or both of a console device or a remote terminal connected thereto, facilitating remote management and control.

According to another preferred embodiment of the present invention, the KVM switch comprises a computer interface, a console interface, a network interface circuit, a processor and a memory. The computer interface is capable of connection to at least one computing device, and the computing device has a baseboard management controller (BMC). The console interface is capable of connection to at least one console device. The network interface circuit is capable of connection to the BMC via a network.

The processor is electrically connected to the computer interface, the console interface and the network interface circuit and routes a communication path between the computing device and the console device. The memory is electrically connected to the processor and stores an Intelligent Platform Management Interface (IPMI) firmware. The processor manages the computing device through the BMC by executing the IPMI firmware and generates an IPMI menu.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic view of a conventional KVM switch connecting several computers and a console device;

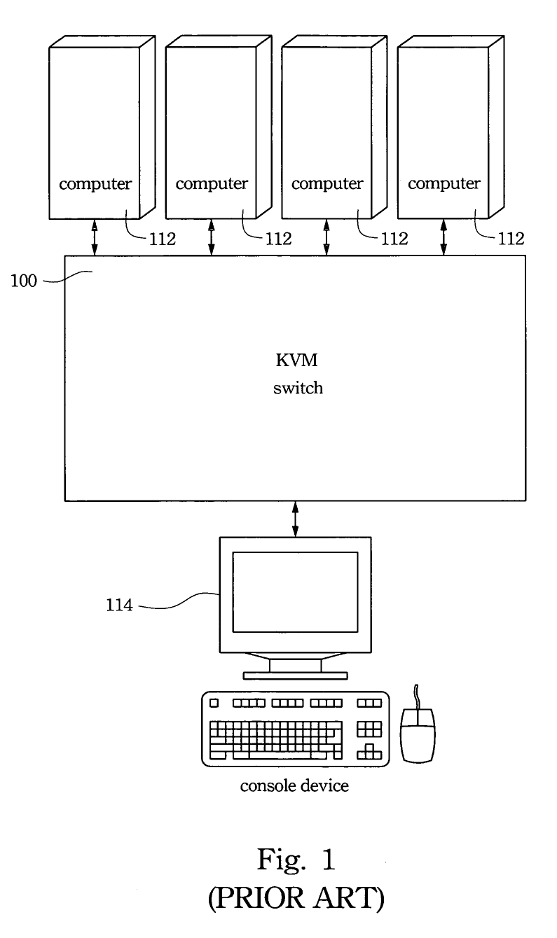

FIG. 2 is a schematic view of a conventional Intelligent Platform Management Interface (IPMI) system;

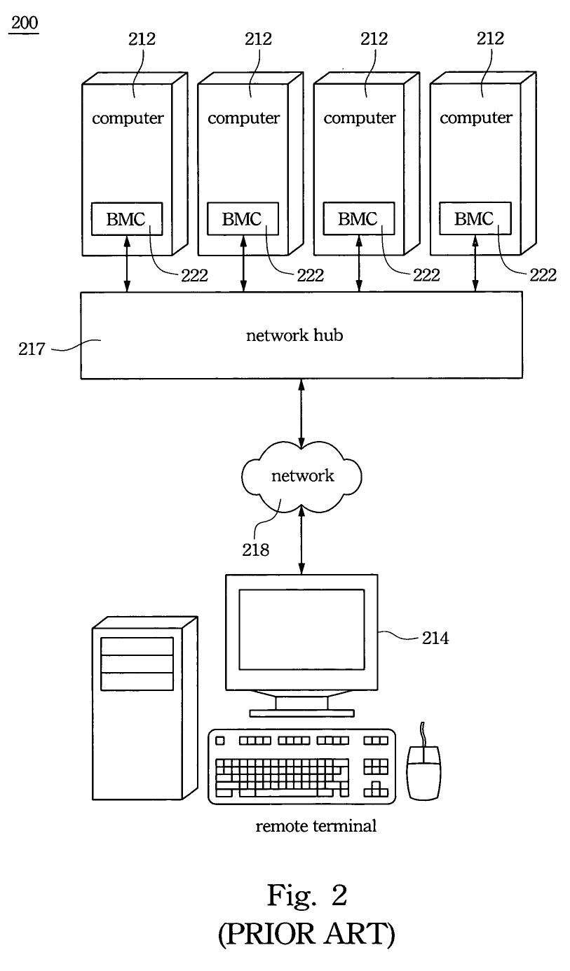

FIG. 3 is a schematic view of one preferred embodiment of the present invention;

FIG. 4 is a schematic view of another preferred embodiment of the present invention; and

FIG. 5 is a schematic view of another preferred embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The present invention integrates an Intelligent Platform Management Interface (IPMI) module into a KVM switch, which provides the IPMI communication with a computing device connected to the KVM switch by a network interface circuit thereof. Therefore, the system administrator or user of the present KVM switch can manage, monitor and route the computing devices connected to the KVM switch via the IPMI function simultaneously, thus facilitating remote management and control.

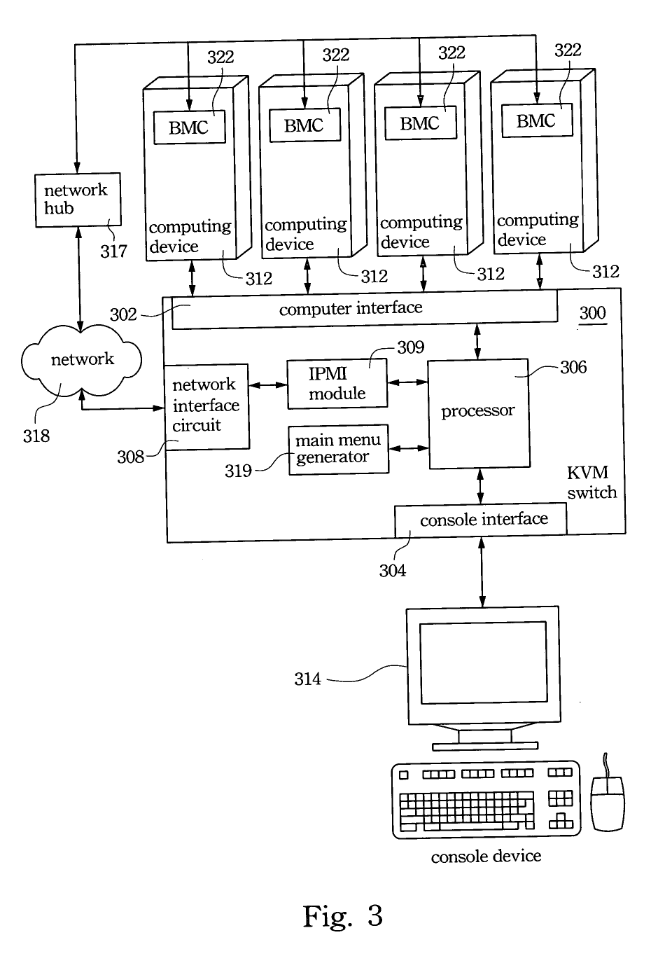

FIG. 3 is a schematic view of one preferred embodiment of the present invention. A KVM switch 300 includes a computer interface 302, a console interface 304, a processor 306, a network interface circuit 308 and an Intelligent Platform Management Interface (IPMI) module 309. The computer interface 302 is capable of connection to at least one computing device 312, and each computing device 312 is installed an IPMI module which has a baseboard management controller (BMC) 322 thereon. The console interface 304 is capable of connection to at least one console device 314.

The processor 306 is electrically connected to the computer interface 302 and the console interface 304 and routes a communication path between the computing device 312 and the console device 314. The network interface circuit 308 is capable of connection to the BMC 322 via a network 318, i.e. by a network hub 317. The BMC 322 provides the intelligence behind Intelligent Platform Management. The BMC 322 manages the interface between system management software and the platform management hardware, providing autonomous monitoring, event logging, and recovery control, and servers as the gateway between system management software and the Intelligent Platform Management Bus (IPMB) and Intelligent Chassis Management Bus (ICMB). The IPMI module 309 is electrically connected to the processor 306 and the network interface circuit 308, manages the computing device 312 via the BMC 322 and the network hub 317, and generates an IPMI menu for the console device 314.

The computing device 312 can be a server, a workstation, a personal computing device, a notebook computer or other the like in which the BMC 322 is configured. The BMC 322 can be a BMC chip embedded in or mounted on the motherboard of the computing device 312, an external interface card plugged onto the computing device 312, or other suitable BMC device internally or externally connected to the computing device 312. It is noted that more than one computing devices 312 and more than one console devices 314 can be connected to and their communication paths can be routed by the KVM switch 300. Meanwhile, not all of the computing devices 312 necessarily have the BMC 322 unless the computing devices 312 are required to support the IPMI standard for user management and control.

The console device 314 typically includes manipulating devices (such as a keyboard and a mouse) and a display device (such as a CRT display or an LCD display). The network environment provided by the network hub 318 can be a local area network (LAN), a wireless area network (WAN) or other communication network.

More precisely, the KVM switch 300 can further include a main menu generator 319, which may present a main menu in OSD method. The main menu generator 319 is electrically connected to the processor 306. For example, the main menu generator 319 can generate a main menu (e.g. an OSD main menu) for the console device 314 after a keystroke or a sequence of keystrokes of the keyboard of the console device 314. The main menu may contain information about a communication path between the computing device 312 and the console device 314 and the system information of the KVM switch 300, and it provides functions of switching, monitoring, management or control by, for example, several different options or submenus in the main menu.

The processor 306 transmits the main menu and the IPMI menu to the console device 314. In the preferred embodiment, the IPMI menu can be combined with the main menu, e.g. an OSD main menu. That is, the IPMI menu is transmitted to the console device 314 by an OSD image and may be represented as an OSD submenu or an OSD single menu of the OSD main menu. Alternatively, the processor 306 can separately transmit the main menu and the IPMI menu according to different instructions from the console device 314, such as by different hotkeys or other input signals. The user thus can call different menus as needed with different instructions.

The IPMI module 309 can be implemented by many different manners and combinations, such as partially or purely by hardware, software or firmware. For example, the IPMI module 309 can be a chip that communicates with and manages the BMC 322 of the computing device 312 by following the IPMI standard, or a processor for executing a firmware coded with the IPMI standard and providing the required IPMI functions, or a software stored in a storage device and simulating the required IPMI functions under a suitable operation system. In the preferred embodiments, the IPMI module 309 comprises a memory, such as a FLASH memory, which stores an IPMI firmware. The processor 306 is electrically connected to the memory and manages the computing device 312 by executing the IPMI firmware.

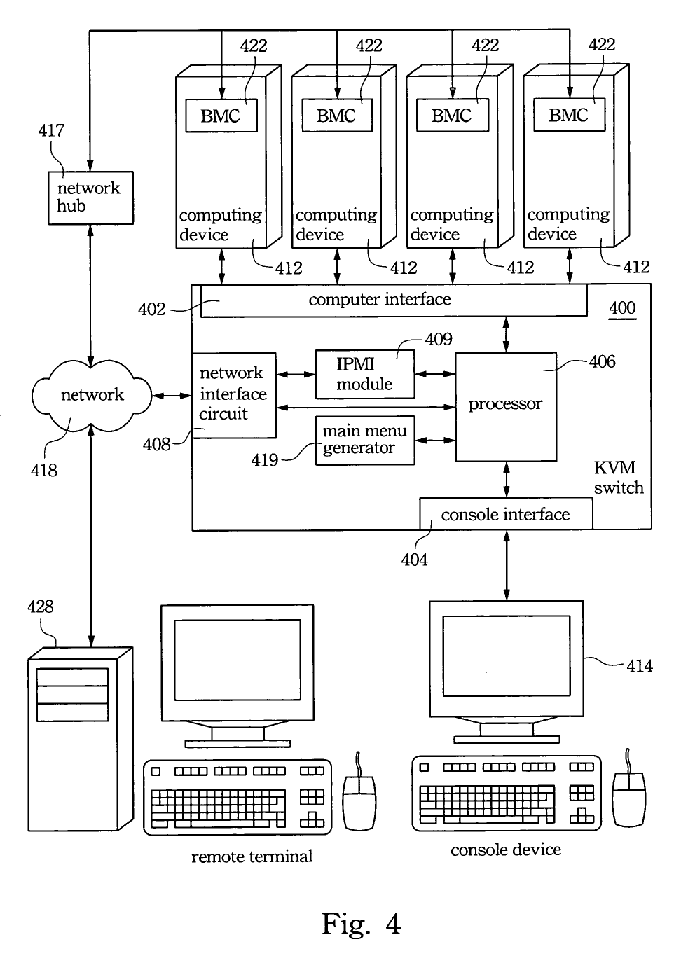

FIG. 4 is a schematic view of another preferred embodiment of the present invention, for illustrating that a KVM switch supporting over-IP technique can provide IPMI services between computing devices and a remote terminal. The over-IP technique makes the KVM switch able to communicate with the remote terminal via the network. Therefore, the remote terminal can remotely manage and control the computing devices, which are directly connected to the KVM switch, through the over-IP and IPMI functions provided by the KVM switch of the preferred embodiment.

Referring to FIG. 4, A KVM switch 400 includes a computer interface 402, a console interface 404, a processor 406, a network interface circuit 408 and an Intelligent Platform Management Interface (IPMI) module 409. The computer interface 402 is capable of connection to at least one computing device 412, and each computing device 412 has a baseboard management controller (BMC) 422 installed thereon. The console interface 404 is capable of connection to at least one console device 414. The network interface circuit 408 is capable of connection to the BMC 422 and a remote terminal 428 via a network 418.

The processor 406 is electrically connected to the computer interface 402, the console interface 404 and the network interface circuit 408, and routes communication paths among the computing device 412, the console device 414 and the remote terminal 428. The BMC 422 provides the intelligence behind Intelligent Platform Management. The BMC 422 manages the interface between system management software and the platform management hardware, providing autonomous monitoring, event logging, and recovery control, and servers as the gateway between system management software and the Intelligent Platform Management Bus (IPMB) and Intelligent Chassis Management Bus (ICMB). The IPMI module 409 is electrically connected to the processor 406 and the network interface circuit 408, manages the computing device 412 by the BMC 422 via the network 418, and generates an IPMI menu for at least one of the console device 414 and the remote terminal 428.

The computing device 412 can be a server, a workstation, a personal computer, a notebook computer or the like in which the BMC 422 is configured. The BMC 422 can be a BMC chip embedded in or mounted on the motherboard of the computing device 412, an external interface card plugged into the computing device 412, or other suitable BMC device internally or externally connected to the computing device 412. It is noted that more than one computing devices 412 and more than one console devices 414 can be connected to and their communication paths routed by the KVM switch 400. Meanwhile, not all of the computing devices 412 necessarily have the BMC 422 unless the computing devices 412 are required to support the IPMI standard for user management and control.

The console device 414 typically includes manipulating devices (such as a keyboard and a mouse) and a display device (such as a CRT display or an LCD display). The remote terminal 428 can be a server, a workstation, a desktop personal computer, a notebook computer or the like which can access the network 418 and act as a terminal. The network 418 can be a local area network (LAN), a wireless area network (WAN) or other communication networks. For example, the network interface circuit 408 can communicate with the BMC 422 and the remote terminal 428 by a network hub 417 via the network 418.

More precisely, the KVM switch 400 can further includes a main menu generator 419, which may present a main menu in OSD method. The main menu generator 419 is electrically connected to the processor 406. For example, after a keystroke or a sequence of keystrokes of the keyboard of the console device 414 or the remote terminal 428, the main menu generator 419 can generate a main menu (e.g. an OSD main menu) for at least one of the console device 414 and the remote terminal 428. The main menu may contain information about communication paths among the computing device 412, the console device 414, the remote terminal 428, and the system information of the KVM switch 400; and it provides functions of switching, monitoring, management or control by, for example, several different options or submenus in the main menu.

The processor 406 transmits the main menu and the IPMI menu to at least one of the console device 414 and the remote terminal 428. In the preferred embodiment, the IPMI menu can be combined with the main menu, e.g. an OSD main menu. That is, the IPMI menu is transmitted to the target by an OSD image and may be represented as an OSD submenu or an OSD single menu of the OSD main menu. Alternatively, the processor 406 can separately transmit the main menu and the IPMI menu according to different instructions from the console device 414 or the remote terminal 428, such as by different hotkeys or other input signals. The user thus can call different menus as needed with different instructions.

The IPMI module 409 can be implemented by many different manners and combinations, such as partially or purely by hardware, software or firmware. For example, the IPMI module 409 can be a chip that communicates and manages the BMC 422 of the computing device 412 by following the IPMI standard, a processor for executing a firmware coded with the IPMI standard and providing the required IPMI functions, or a software stored in a storage device and simulating the required IPMI functions under a suitable operation system. In the preferred embodiments, the IPMI module 409 comprises a memory, such as a FLASH memory, which stores an IPMI firmware. The processor 406 is electrically connected to the memory and manages the computing device 412 by executing the IPMI firmware.

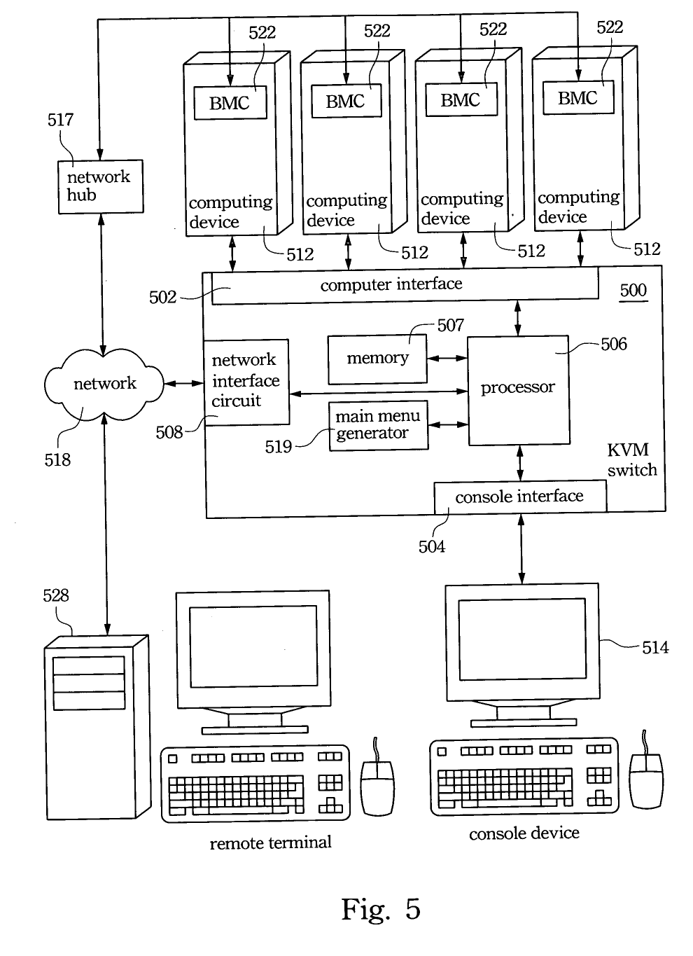

FIG. 5 is a schematic view of another preferred embodiment of the present invention. A KVM switch 500 includes a computer interface 502, a console interface 504, a processor 506, a network interface circuit 508 and a memory 516. The computer interface 502 is capable of connection to at least one computing device 512, and the computing device 512 has a baseboard management controller (BMC) 522. The console interface 504 is capable of connection to at least one console device 514. The network interface circuit 508 is capable of connection to the BMC 522 via a network 518.

The processor 506 is electrically connected to the computer interface 502, the console interface 504 and the network interface circuit 508 and routes a communication path between the computing device 512 and the console device 514. The BMC 522 provides the intelligence behind Intelligent Platform Management. The BMC 522 manages the interface between system management software and the platform management hardware, providing autonomous monitoring, event logging, and recovery control, and servers as the gateway between system management software and the Intelligent Platform Management Bus (IPMB) and Intelligent Chassis Management Bus (ICMB). The memory 507 is electrically connected to the processor 506 and stores an Intelligent Platform Management Interface (IPMI) firmware. The processor 506 manages the computing device 512 through the BMC 522 by executing the IPMI firmware and generates an IPMI menu.

The computing device 512 can be a server, a workstation, a desktop personal computer, a notebook computer or the like in which the BMC 522 is configured. The BMC 522 can be a BMC chip embedded in or mounted on the motherboard of the computing device 512, an external interface card plugged into the computing device 512, or other suitable BMC device internally or externally connected to the computing device 512. According to another preferred embodiment of the present invention, when more than one computing devices 512, such as blade servers stacked in a rack, are connected to the computer interface 502, the processor 506 manages these blade servers through one baseboard management controller shared by the blade serversand the Intelligent Chassis Management Bus (ICMB).

It is noted that more than one computing devices 512 and more than one console devices 514 can be connected to and their communication paths can be routed by the KVM switch 500. Meanwhile, not all of the computing devices 512 necessarily have the BMC 522 unless the computing devices 512 are required to support the IPMI standard for user management and control.

The console device 514 typically includes manipulating devices (such as a keyboard and a mouse) and a display device (such as a CRT display or an LCD display). The network 518 can be a local area network (LAN), a wireless area network (WAN) or other communication network. For example, the network interface circuit 508 can communicate with the BMC 522 by a network hub 517 via the network 518.

Moreover, the network interface circuit 508 is further capable of connection to a remote terminal 528 via the network 518; the processor 506 further routes communication paths among the computing device 512, the console device 514 and the remote terminal 528; and the IPMI menu is selectively generated for at least one of the console device 514 and the remote terminal 528. The remote terminal 528 can be a server, a workstation, a personal computing device, a notebook computing device or other computing device which can access the network and act as a terminal. In addition, the memory 507 can be a FLASH memory or other suitable memory device.

More precisely, the KVM switch 500 can further comprise a menu generator 519, which may present a main menu in OSD method. The main menu generator 519 is electrically connected to the processor 506. For example, after a keystroke or a sequence of keystrokes of the keyboard of the console device 514 or the remote terminal 528, the main menu generator 519 can generate a main menu (e.g. an OSD main menu) for at least one of the console device 514 and the remote terminal 528. The main menu may contain information about communication paths among the computing device 512, the console device 514, the remote terminal 528, and the system information of the KVM switch 500; and it provides functions of switching, monitoring, management or control by, for example, several different options or submenus in the main menu.

The processor 506 transmits the main menu and the IPMI menu to at least one of the console device 514 and the remote terminal 528. In the preferred embodiment, the IPMI menu can be combined with the main menu, e.g. an OSD main menu. That is, the IPMI menu is transmitted to the target by an OSD image and may be represented as an OSD submenu or an OSD single menu of the OSD main menu. Alternatively, the processor 506 can separately transmit the main menu and the IPMI menu according to different instructions from the console device 514 or the remote terminal 528, such as by different hotkeys or other input signals. The user thus can call different menus as needed with different instructions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A KVM switch, comprising:
a computer interface capable of connection to at least one computing device, wherein the computing device has a baseboard management controller;
a console interface capable of connection to at least one console device;
a processor electrically connected to the computer interface and the console interface, and arranged to route a communication path between the computing device and the console device;
a network interface circuit capable of connection to the baseboard management controller via a network; and
an Intelligent Platform Management Interface module electrically connected to the processor and the network interface circuit, and arranged to manage the computing device by the baseboard management controller via the network and generate an Intelligent Platform Management Interface menu for the console device.

2. The KVM switch as claimed in claim 1, further comprising:
a main menu generator electrically connected to the processor and arranged to generate a main menu for the console device.

3. The KVM switch as claimed in claim 2, wherein the Intelligent Platform Management Interface menu is combined with the main menu.

4. The KVM switch as claimed in claim 2, wherein the processor is arranged to transmit the main menu and the Intelligent Platform Management Interface menu to the console device.

5. The KVM switch as claimed in claim 4, wherein the main menu and the Intelligent Platform Management Interface menu are separately transmitted to the console device according to different instructions from the console device.

6. The KVM switch as claimed in claim 1, wherein the Intelligent Platform Management Interface module further comprises:
a memory arranged to store an Intelligent Platform Management Interface firmware.

7. A KVM switch, comprising:
a computer interface capable of connection to at least one computing device, wherein the computing device has a baseboard management controller;
a console interface capable of connection to at least one console device;
a network interface circuit capable of connection to the baseboard management controller and a terminal via a network;
a processor electrically connected to the computer interface, the console interface and the network interface circuit, and arranged to route communication paths among the computing device, the console device and the remote terminal; and
an Intelligent Platform Management Interface module electrically connected to the processor and the network interface circuit, and arranged to manage the computing device by the baseboard management controller via the network and generate an Intelligent Platform Management Interface menu for at least one of the console device and the remote terminal.

8. The KVM switch as claimed in claim 7, further comprising:
a main menu generator electrically connected to the processor, and arranged to generate a main menu for at least one of the console device and the remote terminal.

9. The KVM switch as claimed in claim 8, wherein the Intelligent Platform Management Interface menu is combined with the main menu.

10. The KVM switch as claimed in claim 8, wherein the processor is arranged to transmit the main menu and the Intelligent Platform Management Interface menu to at least one of the console device and the remote terminal.

11. The KVM switch as claimed in claim 10, wherein the main menu and the Intelligent Platform Management Interface menu are separately transmitted to the console device according to different instructions from the console device or the remote terminal.

12. The KVM switch as claimed in claim 7, wherein the Intelligent Platform Management Interface module further comprises:
a memory arranged to store an Intelligent Platform Management Interface firmware.

13. A KVM switch, comprising:
a computer interface capable of connection to at least one computing device, wherein the computing device has a baseboard management controller;
a console interface capable of connection to at least one console device;
a network interface circuit capable of connection to the baseboard management controller via a network;
a processor electrically connected to the computer interface, the console interface and the network interface circuit, and arranged to route a communication path between the computing device and the console device;
a memory electrically connected to the processor, and arranged to store an Intelligent Platform Management Interface firmware;
wherein the processor is arranged to manage the computing device through the baseboard management controller by executing the Intelligent Platform Management Interface firmware and generate an Intelligent Platform Management Interface menu.

14. The KVM switch as claimed in claim 13, wherein the network interface circuit is further capable of connection to a remote terminal via the network, the processor is further arranged to route communication paths among the computing device, the console device and the remote terminal, and the Intelligent Platform Management Interface menu is selectively generated for at least one of the console device and the remote terminal.

15. The KVM switch as claimed in claim 14, further comprising:
a main menu generator electrically connected to the processor, and arranged to generate a main menu for at least one of the console device and the remote terminal.

16. The KVM switch as claimed in claim 15, wherein the Intelligent Platform Management Interface menu is combined with the main menu.

17. The KVM switch as claimed in claim 15, wherein the processor is arranged to transmit the main menu and the Intelligent Platform Management Interface menu to at least one of the console device and the remote terminal.

18. The KVM switch as claimed in claim 17, wherein the main menu and the Intelligent Platform Management Interface menu are separately transmitted to the console device according to different instructions from the console device is or the remote terminal.

19. The KVM switch as claimed in claim 13, wherein when a plurality of computing devices are connected to the computer interface, the processor is arranged to manage the computing devices through one baseboard management controller shared by the computing devices.

20. A KVM switch, comprising:
a computer interface capable of connection to a plurality of computing devices, wherein the computing devices share a baseboard management controller;
a console interface capable of connection to at least one console device;
a network interface circuit capable of connection to the baseboard management controller via a network;
a processor electrically connected to the computer interface, the console interface and the network interface circuit, and arranged to route communication paths among the computing devices and the console device; and
a memory electrically connected to the processor, and arranged to store an Intelligent Platform Management Interface firmware;
wherein the processor is arranged to manage the computing devices through the baseboard management controller by executing the Intelligent Platform Management Interface firmware.
